(19) United States
(12) Patent Application Publication
(10) Pub. No.: US 2025/0024074 A1
(43) Pub. Date: Jan. 16, 2025

(54) METHOD OF ENCODING/DECODING DYNAMIC MESH AND RECORDING MEDIUM STORING METHOD OF ENCODING/DECODING DYNAMIC MESH

(71) Applicant: Electronics and Telecommunications Research Institute, Daejeon (KR)

(72) Inventors: Da Yun NAM, Daejeon (KR); Seong Yong LIM, Daejeon (KR); Hyun Cheol KIM, Daejeon (KR); Chae Eun RHEE, Incheon (KR); Yong Wook SEO, Incheon (KR); Hyun Min JUNG, Incheon (KR)

(73) Assignee: Electronics and Telecommunications Research Institute, Daejeon (KR)

(21) Appl. No.: 18/770,991

(22) Filed: Jul. 12, 2024

(30) Foreign Application Priority Data
Jul. 13, 2023 (KR) 10-2023-0091388
Jun. 27, 2024 (KR) 10-2024-0084731

(51) Int. Cl. H04N 19/597; G06T 17/20; H04N 19/117; H04N 19/82

(52) U.S. Cl. CPC H04N 19/597; G06T 17/20; H04N 19/117; H04N 19/82

(57) ABSTRACT

A method of encoding a dynamic mesh includes creating a base mesh through mesh decimation, subdividing the base mesh, extracting displacement information for the subdivided mesh, and encoding the base mesh and the displacement information. In this instance, mesh subdivision information for subdivision of the base mesh is encoded and signaled.

### BACKGROUND OF THE INVENTION

### Field of the Invention

The present disclosure relates to a method of encoding/decoding a dynamic mesh.

### Description of the Related Art

Static or dynamic 2D data may generally be encoded/decoded using image or video compression codecs such as AVC, HEVC or VVC. Due to high compression performance of the compression codecs, a method of using the compression codecs to compress immersive video or mesh has continuously been studied.

### SUMMARY OF THE INVENTION

It is another object of the present disclosure to provide a method of subdividing a base mesh generated through mesh simplification when encoding/decoding a dynamic mesh.

It is a further object of the present disclosure to provide a method of subdividing a base mesh based on a plurality of mesh subdivision type candidates.

It is a further object of the present disclosure to provide a method of variably setting a mesh subdivision type for each subdivision iteration.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of encoding a dynamic mesh, the method including creating a base mesh through mesh decimation, subdividing the base mesh, extracting displacement information for the subdivided mesh, and encoding the base mesh and the displacement information. In this instance, mesh subdivision information for subdivision of the base mesh is encoded and signaled.

In the method of encoding the dynamic mesh according to the present disclosure, the mesh subdivision information may include first information indicating whether mesh subdivision is applied to the base mesh.

In the method of encoding the dynamic mesh according to the present disclosure, when the mesh subdivision is applied to the base mesh, the mesh subdivision information may further include second information indicating a number of subdivisions of the base mesh.

In the method of encoding the dynamic mesh according to the present disclosure, when the base mesh is subdivided a plurality of times, information indicating a mesh subdivision type may be encoded and signaled for each iteration, and the mesh subdivision type may indicate one of a plurality of mesh subdivision type candidates.

In the method of encoding the dynamic mesh according to the present disclosure, when the base mesh is subdivided a plurality of times, a default mesh subdivision type may be applied in a first iteration, and one of the plurality of mesh subdivision type candidates may be optionally used in second and subsequent iterations.

In the method of encoding the dynamic mesh according to the present disclosure, encoding of mesh subdivision type information may be omitted for the first iteration, and mesh subdivision type information indicating one of the plurality of mesh subdivision type candidates may be encoded in the second and subsequent iterations.

In the method of encoding the dynamic mesh according to the present disclosure, when the base mesh is subdivided, one of a plurality of subdivision type candidates may be adaptively determined based on a number of vertices included in the base mesh.

In the method of encoding the dynamic mesh according to the present disclosure, the method may further include applying an in-loop filter to the subdivided mesh or a reconstructed mesh based on the subdivided mesh.

In the method of encoding the dynamic mesh according to the present disclosure, a type of the in-loop filter may be adaptively determined according to a mesh subdivision type of the base mesh.

In accordance with another aspect of the present disclosure, there is provided a method of decoding a dynamic mesh, the method including decoding a base mesh, subdividing the base mesh, decoding displacement information, and restoring a mesh by applying the displacement information to a subdivided mesh. In this instance, subdivision of the base mesh is performed based on mesh subdivision information decoded from a bitstream.

Meanwhile, in the present disclosure, it is possible to provide a computer-readable recording medium recording the method of encoding the dynamic mesh.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an encoder for encoding a dynamic mesh;

FIG. 2 is a block diagram of a decoder for decoding the dynamic mesh;

FIGS. 3 and 4 illustrate examples in which additional vertices are created by midpoint subdivision;

FIG. 5 illustrates an example in which a mesh subdivision type is independently determined for each subdivision iteration;

FIG. 6 illustrates an example in which a fixed mesh subdivision type is used for each iteration;

FIG. 7 illustrates a refined mesh output through an in-loop filter;

FIG. 8 is a diagram for describing a time point when the in-loop filter is applied;

FIG. 9 illustrates an example in which the in-loop filter is applied to a reconstructed mesh;

FIG. 10 is a flowchart of a method of encoding the dynamic mesh according to an embodiment of the present disclosure; and

FIG. 11 is a flowchart of a method of decoding the dynamic mesh according to an embodiment of the present disclosure.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. For example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. For example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

A dynamic mesh, which is volumetric media, may be compressed by distinguishing between geometric information and attribute information. Specifically, each of geometric information of vertices included in the dynamic mesh and attribute information of faces may be encoded/decoded. Here, a face may have a triangular shape including three vertices.

The geometric information represents a position of a vertex in a three-dimensional (3D) space and may be expressed in the form of a displacement vector. The attribute information may represent texture, etc.

The attribute information of the dynamic mesh may be encoded/decoded through a general video codec, such as HEVC, VVC, or AV1.

The geometric information of each vertex may be encoded/decoded separately from the attribute information. However, since the number of vertices included in the mesh is significantly large, encoding/decoding thereof without change has a problem of lowering compression efficiency. Accordingly, mesh decimation and mesh subdivision techniques may be applied to encode/decode the geometric information.

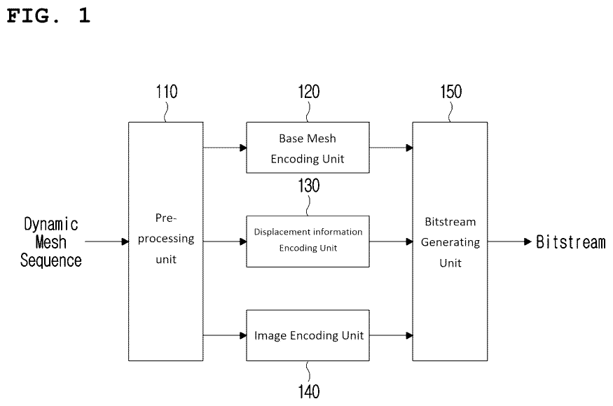

FIG. 1 is a block diagram of an encoder for encoding a dynamic mesh.

Referring to FIG. 1, the encoder may include a pre-processing unit 110, a base mesh encoding unit 120, a displacement information encoding unit 130, an image encoding unit 140, and a bitstream generating unit 150.

The pre-processing unit 110 performs mesh decimation on dynamic mesh input. Mesh decimation refers to reducing the number of vertices included in the mesh to reduce the amount of data to be encoded/decoded. Through mesh decimation, a base mesh, which is a basic structure of a mesh, may be generated. That is, the base mesh may have fewer vertices and faces than those of an original mesh. Meanwhile, a vertex included in the base mesh may be referred to as a basic vertex.

However, as the number of vertices included in the mesh decreases, mesh restoration quality in the decoder more deteriorates. To reduce this problem, additional vertices may be generated by applying mesh subdivision technique to the base mesh. A subdivided mesh may include an additional vertex generated through mesh subdivision in addition to basic vertices.

The pre-processing unit 110 may generate an atlas by packing attribute information of each face included in the mesh in a 2D image. Further, the preprocessor 110 may generate mapping information between a face packed in the atlas and a face of the subdivided mesh. Meanwhile, each of faces packed in the atlas may be referred to as a patch.

The pre-processing unit 110 may generate displacement information for the subdivided mesh. The displacement information may include a displacement vector representing a difference between a position of a vertex in the subdivided mesh and a position of a corresponding vertex in the original mesh.

The base mesh encoding unit 120, the displacement information encoding unit 130, and the image encoder 140 each encode data generated through the pre-processing unit 110.

Specifically, the base mesh encoding unit 120 encodes the base mesh generated in the preprocessing unit 110.

Meanwhile, the base mesh may be encoded through an intra mode or an inter mode. When the inter mode is applied, a base mesh of a current frame may be derived based on a base mesh of a reference frame. Specifically, by compensating for motion of each vertex in the base mesh of the reference frame, the base mesh for the current frame may be derived.

When the base mesh is encoded in the inter mode, motion information may be encoded and signaled.

The displacement information encoding unit 130 encodes displacement information about vertices included in the subdivided mesh. Here, the displacement information is used to determine a position of a vertex in a 3D space and may include a displacement vector. The displacement vector represents a difference between a current position of a vertex in the subdivided mesh and a position of the corresponding vertex in the original mesh.

The image encoding unit 140 encodes attribute information. As an example, the image encoding unit 140 may encode an atlas in which faces of a mesh are packed.

Meanwhile, the displacement information encoding unit 130 and the image encoding unit 140 may operate based on codec technology such as VVC, HEVC, or AV1.

The bitstream generating unit 150 multiplexes the encoded data and generates a bitstream.

Meanwhile, metadata may be generated and encoded so that a reverse process of a preprocessing process performed in the pre-processing unit 110 of the encoder may be performed. The bitstream may further include the metadata.

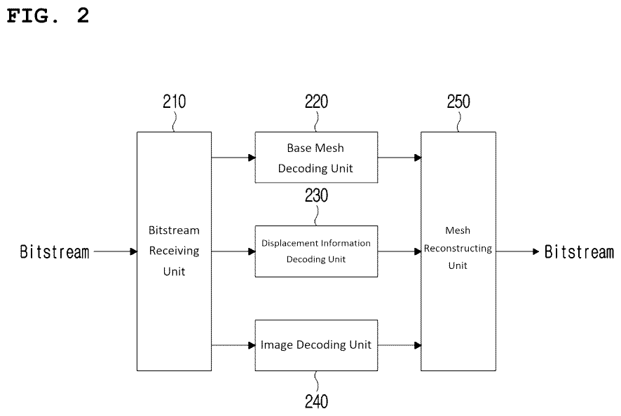

Referring to FIG. 2, the decoder may include a bitstream receiving unit 210, a base mesh decoding unit 220, a displacement information decoding unit 230, an image decoding unit 240, and a mesh reconstruction unit 250.

The bitstream receiving unit 210 demultiplexes the received bitstream and derives a plurality of pieces of encoded data. As an example, encoded attribute data, encoded base mesh data, and encoded geometry data may be derived through bitstream demultiplexing.

The base mesh decoding unit 220 decodes the encoded base mesh. Meanwhile, the base mesh may be decoded through the intra mode or the inter mode. When the inter mode is applied, the base mesh of the current frame may be derived based on the base mesh of the reference frame.

The displacement information decoding unit 230 decodes the encoded displacement information. The displacement information is used to determine a position of a vertex in the 3D space and may include a displacement vector.

The image decoding unit 240 decodes the attribute information. As an example, the image decoding unit 240 may decode an atlas in which a plurality of patches is packed.

The mesh reconstruction unit 250 performs mesh subdivision on the decoded base mesh, adds the displacement information to the subdivided mesh, and restores the geometric information of the mesh. In addition, the mesh reconstructing unit 250 may reconstruct the mesh by adding decoded attribute information to the mesh.

As described above, by creating a base mesh through mesh decimation and encoding/decoding the base mesh instead of the original mesh, data that needs to be encoded/decoded may be reduced. However, when the mesh is restored using only the base mesh, a problem occurs in which quality of the restored mesh deteriorates. To prevent the above problem, additional vertices may be generated by performing mesh subdivision on the base mesh. In the decoder, additional vertices may be generated by performing mesh subdivision on the base mesh using the same method as that for the encoder.

To perform mesh subdivision in the decoder using the same method as that for the encoder, information about a mesh subdivision type used in the encoder may be encoded and signaled.

The information about the mesh subdivision type may include at least one of information indicating whether mesh subdivision has been performed on the base mesh or information for identifying a mesh subdivision method applied to the base mesh among a plurality of mesh subdivision method candidates.

Meanwhile, in the encoder and the decoder, mesh subdivision on the base mesh may be performed using a default mesh subdivision type. In this case, only information indicating whether mesh subdivision has been performed on the base mesh may be encoded and signaled. As an example, Table 1 shows an example of a method in which mesh subdivision is indicated according to a value of syntax asps_vdmc_ext_subdivision_method.

TABLE 1

| asps_vdmc_ext_subdivision_method | Name of subdivision method |
|---|---|
| 0 | NONE |
| 1 | MIDPOINT |

As illustrated in Table 1, when mesh subdivision is not applied to the base mesh, encoding may be performed by setting the value of syntax asps_vdmc_ext_subdivision_method to 0. On the other hand, when mesh subdivision is applied to the base mesh, encoding may be performed by setting the value of syntax asps_vdmc_ext_subdivision_method to 1.

The default subdivision method may be midpoint subdivision, as in the example of Table 1.

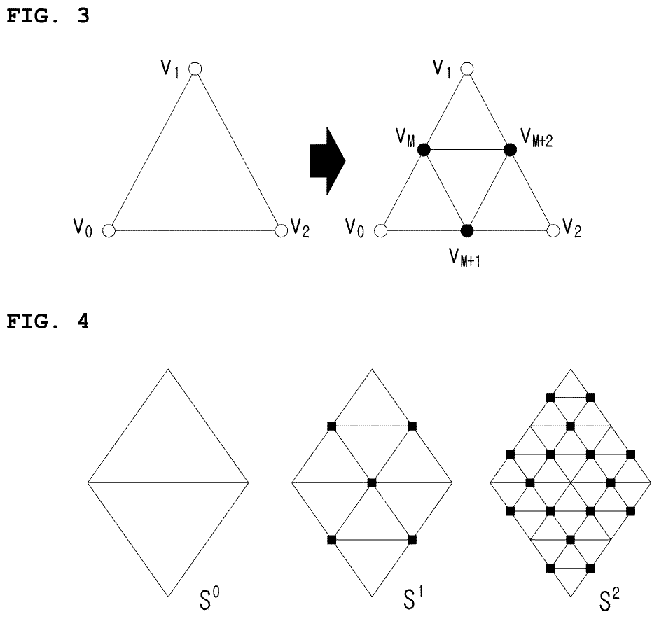

FIGS. 3 and 4 illustrate examples in which additional vertices are generated by midpoint subdivision.

As in the example shown in FIG. 3, when midpoint subdivision is applied, a center position between two adjacent vertices may be set as an additional vertex. As an example, as in the example shown in FIG. 3, an additional vertex v_{M} may be generated at a midpoint of v₀ and v₁, an additional vertex v_{M+1} may be generated at a midpoint of v₀ and v₂, and an additional vertex v_{M+2} may be generated at a midpoint of v₁ and v₂.

When additional vertices are generated, a new polygon may be constructed by constructing connecting lines between the additional vertices.

Meanwhile, mesh subdivision may be repeatedly performed until enough vertices are generated. For example, as in the example shown in FIG. 4, midpoint subdivision may be applied twice (S¹ and S²) based on midpoint subdivision.

Mesh subdivision may be performed using a mesh subdivision type other than the default mesh subdivision type. In this instance, the mesh subdivision type candidates that may be selected by the encoder and the decoder include at least one of midpoint subdivision, loop subdivision, butterfly subdivision, or LS3 (Lease Square Subdivision Surfaces).

In this case, a range of values that syntax asps_vdmc_ext_subdivision_method may have is increased as shown in Table 2 to determine whether mesh subdivision has been performed on the base mesh and the mesh subdivision type.

TABLE 2

| asps_vdmc_ext_subdivision_method | Name of subdivision method |
|---|---|
| 0 | NONE |
| 1 | MIDPOINT |
| 2 | Loop |
| 3 | Butterfly |
| 4 | LS3 |
| 5 | Reserved |

As in the example of Table 2, when the value of syntax asps_vdmc_ext_subdivision_method is 0, the value indicates that mesh subdivision has not been performed on the base mesh. On the other hand, when the value of syntax asps_vdmc_ext_subdivision_method is 1 or more, the value indicates that mesh subdivision has been performed on the base mesh. When the value of syntax asps_vdmc_ext_subdivision_method is not 0, one of the plurality of mesh subdivision type candidates may be selected according to the value of syntax asps_vdmc_ext_subdivision_method.

As another example, information indicating whether mesh subdivision is performed on the base mesh and information indicating the subdivision type of the mesh may be encoded/decoded using separate syntax. In this case, information indicating one of the plurality of mesh subdivision method candidates may be encoded/decoded only when mesh subdivision is performed on the base mesh.

As an example, syntax vdmc_subdivision_enable_flag indicating whether mesh subdivision has been performed on the base mesh may be encoded/decoded. When the value of syntax vdmc_subvidison_enable_flag is 1, the value indicates that mesh subdivision has been performed on the base mesh. In this case, syntax vdmc_subdivision_method indicating the mesh subdivision type may be encoded/decoded. Syntax vdmc_subdivision_method may indicate one of a plurality of subdivision type candidates.

Meanwhile, when mesh subdivision is applied to the base mesh, information about the number of mesh subdivisions may be additionally encoded/decoded. As an example, syntax vdmc_subdivision_iteration_count indicates the number of subdivisions of the base mesh.

Alternatively, syntax vdmc_subdivision_iteration_count_minus1, which is derived by subtracting 1 from the number of subdivisions of the mesh, may be encoded/decoded.

For the base mesh, when mesh subdivision is performed a plurality of times, the mesh subdivision types over a plurality of iterations may be the same. That is, when the mesh subdivision type for the base mesh is determined by vdmc_subdivision_method, the determined mesh subdivision type may be commonly applied to repeated subdivision iterations.

Alternatively, when mesh subdivision is performed a plurality of times on the base mesh, the mesh subdivision type may be individually determined for each iteration. In this case, syntax vdmc_subdivision_method indicating the mesh subdivision type may be encoded/decoded at each iteration.

FIG. 5 illustrates an example in which a mesh subdivision type is independently determined for each subdivision iteration.

FIG. 5 illustrates that midpoint subdivision is applied in the first subdivision iteration, and LS3 is applied in the second subdivision iteration.

Table 3 shows a syntax table structure in which the mesh subdivision type is encoded/decoded for each iteration.

TABLE 3

| | Descriptor |
|---|---|
| vdmc_subdivision ( ) { | |
| vdmc_subdivision_enable_flag | u(1) |
| if(vdmc_subdivision_enable_flag){ | |
| vdmc_subdivision_iteration_count | u(8) |
| if(vdmc_subdivision_iteration_count >0){ | |
| for(i=0; i< | |
| vdmc_subdivision_iteration_count; i++){ | |
| vdmc_subdivision_method[ i ] | u(3) |
| } | |
| } | |
| } | |
| } | |

Table 3 illustrates that, upon determining that mesh subdivision is performed by syntax vdmc_subdivision_enable_flag, the number of mesh subdivisions is determined based on syntax vdmc_subdivision_iteration_count. In addition, Table 3 illustrates that, when the number of subdivisions is determined by vdmc_subdivision_iteration_count, vdmc_subdivision_method[i] is encoded/decoded for each iteration. Here, i represents the subdivision iteration and may fall within a range from 0 to (vdmc_iteration_count−1).

As another example, in the first subdivision iteration, the default mesh subdivision type may be applied. In this case, in the first subdivision iteration, encoding/decoding of syntax vdmc_subdivison_method[i] may be omitted.

Alternatively, when mesh subdivision is performed a plurality of times, information indicating whether the mesh subdivision type of each iteration is individually determined may be encoded/decoded. As an example, the information may be a 1-bit flag (e.g., vdmc_subdivision_adaptive_flag). The flag may be encoded/decoded when the number of mesh subdivisions is plural (i.e., when the vdmc_subdivision_iteration_count is greater than 2). When the flag indicates that the mesh subdivision type of each iteration is determined individually/independently, syntax vdmc_subdivision_method[i] may be encoded/decoded for each iteration. On the other hand, when the flag indicates that the mesh subdivision type of each iteration is not determined individually/independently, a single vdmc_subdivision_method may be encoded/decoded. In this case, the mesh subdivision type indicated by vdmc_subdivision_method may be applied across all iterations. Or, when the flag indicates that the mesh subdivision type of each iteration is not determined individually/independently, a default mesh subdivision type may be applied across all iterations. Here, the default mesh subdivision type is a midpoint subdivision.

Meanwhile, for each subdivision iteration, at least one of the number or types of selectable mesh subdivision type candidates may be different. As an example, a mesh subdivision type used in the previous iteration or the second iteration may be set as unavailable in the current iteration.

Alternatively, midpoint subdivision may be selectable only in the first iteration and may not be selectable from the second iteration onwards.

When the number of selectable mesh subdivision type candidates is different for each subdivision iteration, the number of bits allocated to syntax vdmc_subdivision_method may be different for each subdivision iteration.

As another example, the encoder/decoder may adaptively determine the mesh subdivision type based on the number of vertices. In this case, encoding/decoding of syntax vdmc_subdivision_method indicating the mesh subdivision type may be omitted. For example, when the number of vertices included in the mesh is less than A (that is, count(vertex)<A), midpoint subdivision may be selected. Availability and mesh subdivision type may be adaptively determined. On the other hand, when the number of vertices included in the mesh is A or more and less than B (that is, A≤count(vertex)<B), LS3 may be selected. On the other hand, when the number of vertices included in the mesh is B or more (that is, B≤count(vertex)), loop subdivision may be selected.

As another example, a mesh subdivision type may be predefined for each subdivision iteration.

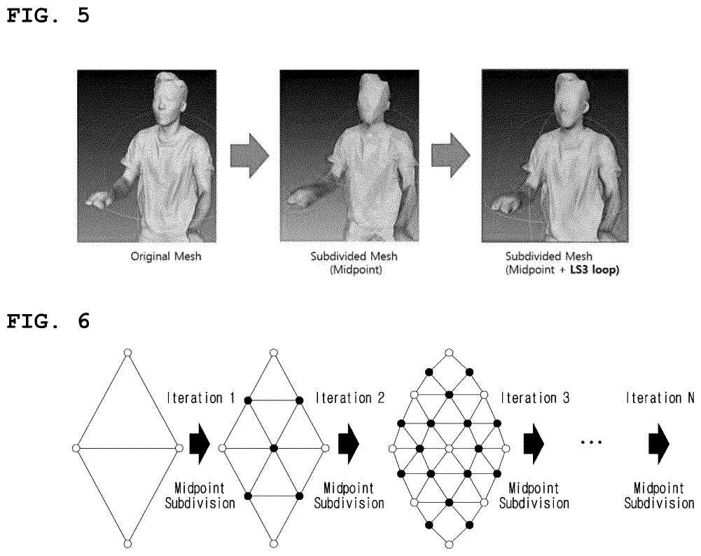

FIG. 6 illustrates an example in which a fixed mesh subdivision type is used for each iteration.

As in the example shown in FIG. 6, in the first iteration, midpoint subdivision may be fixedly used, and in the second and third iterations, loop subdivision may be fixedly used. In addition, in the fourth and subsequent iterations, midpoint subdivision may be fixedly used.

Meanwhile, whether to perform additional mesh subdivision may be determined based on whether a sufficient number of vertices has been generated by mesh subdivision. As an example, the number of vertices generated by mesh subdivision may be compared with a threshold value, and when the number of vertices is greater than or equal to the threshold value, additional mesh subdivision may be set not to be performed. On the other hand, when the number of vertices generated by mesh subdivision is less than the threshold value, mesh subdivision may be additionally performed. Whether or not to perform mesh subdivision is determined by the number of vertices. In this case, encoding/decoding of syntax vdmc_subdivision_iteration_count indicating the number of mesh subdivisions may be omitted.

Meanwhile, before performing mesh subdivision, after performing mesh subdivision, or after reconstructing the mesh, in-loop mesh filtering and smoothing processes (hereinafter referred to as in-loop filter) may be performed in the encoder and the decoder.

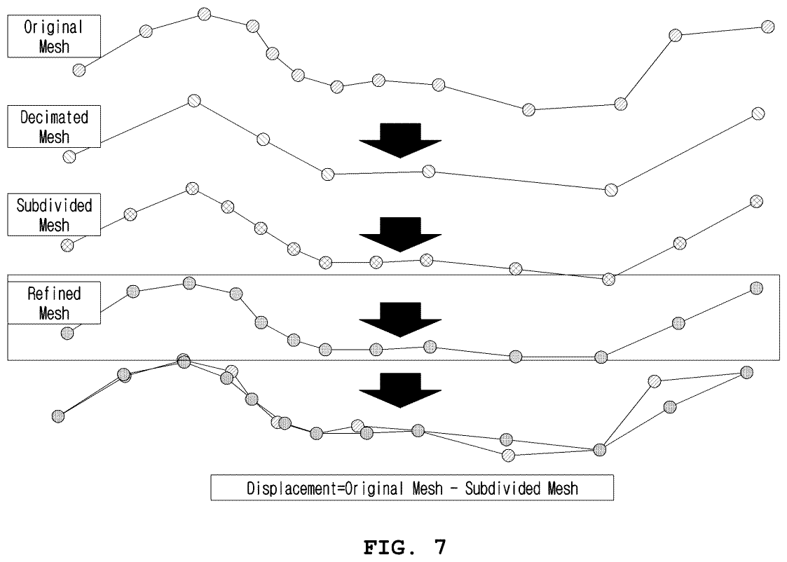

FIG. 7 illustrates a refined mesh output through an in-loop filter.

By readjusting positions of vertices in the mesh subject to in-loop filtering, a refined mesh may be output. In this instance, readjustment of the vertex positions may be performed based on position information of a neighboring vertex group located spatially or temporally adjacent to the vertex.

FIG. 7 illustrates that the in-loop filter is applied to the subdivided mesh. However, the present disclosure is not limited thereto.

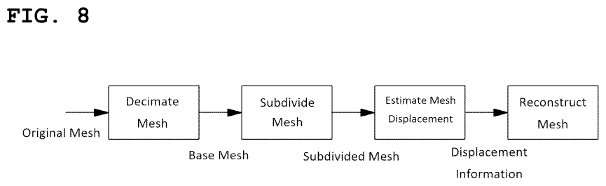

FIG. 8 is a diagram for describing a time point when the in-loop filter is applied.

The in-loop filter may be applied to the base mesh. In other words, before performing mesh subdivision, the in-loop filter may be applied to the base mesh generated by mesh simplification.

In the decoder, after decoding the base mesh, the in-loop filter may be applied to the decoded base mesh.

Meanwhile, when encoding displacement information, whether to apply the in-loop filter to the base mesh may be determined based on at least one of a size of a quantization parameter or the number of repetitions of a mesh subdivision process.

As another example, the in-loop filter may be applied to the subdivided mesh. That is, after the mesh subdivision process is completed and before displacement information is extracted, the in-loop filter may be applied to the subdivided mesh to increase similarity with the original mesh.

In the decoder, after applying mesh subdivision to the base mesh, the in-loop filter may be applied to the subdivided mesh.

Meanwhile, depending on the mesh subdivision type, whether to apply the in-loop filter or at least one of the in-loop filter type may be adaptively determined.

For example, when the mesh subdivision type is midpoint subdivision, a 9-tap filter may be selected as an in-loop filtering technique for the subdivided mesh. Here, the 9-tap filter may refer to a vertex at the center position and eight neighboring vertices adjacent thereto.

On the other hand, when the mesh subdivision type is a butterfly subdivision, a 3-tap filter may be selected as an in-loop filtering technique for the subdivided mesh. Here, the 3-tap filter may refer to the vertex at the center position and two neighboring vertices adjacent thereto.

As another example, the in-loop filter may be applied to the reconstructed mesh. In this instance, depending on the mesh hierarchical subdivision structure (mesh hierarchical partitioning) or coding unit, the in-loop filter may be applied to vertices located in a subdivision boundary region for each subdivision structure. Here, mesh subdivision may include at least one of a tile, a slice, a subpicture, a coding tree unit, or a coding unit.

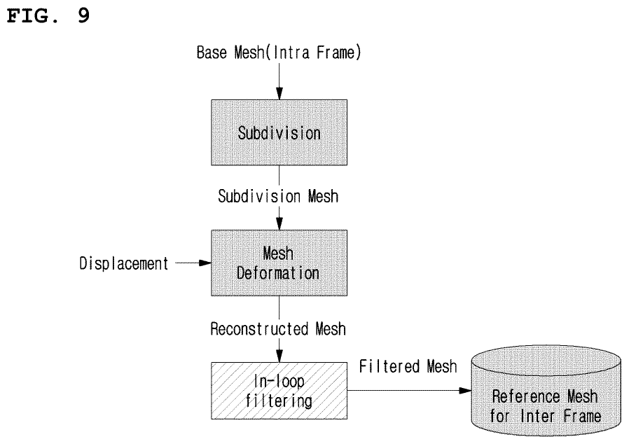

FIG. 9 illustrates an example in which the in-loop filter is applied to the reconstructed mesh.

As in the example illustrated in FIG. 9, when the in-loop filter is applied to the reconstructed mesh, the mesh to which the in-loop filter is applied may be saved as a reference mesh for inter-prediction.

Alternatively, unlike the example illustrated in FIG. 9, the reconstructed mesh before the in-loop filter is applied may be stored as a reference mesh for inter-prediction.

Meanwhile, at least one of information indicating whether the in-loop filter is applied or a time point when the in-loop filter is applied may be encoded and signaled.

For example, information indicating whether the in-loop filter is applied may be a 1-bit flag.

As an example, information indicating an application position of the in-loop filter may be an index indicating one of a plurality of candidate positions. Alternatively, at each time point, a 1-bit flag indicating whether the in-loop filter is applied may be encoded and signaled. Here, each position may include at least one of a time point when the base mesh is restored, a time point when the base mesh is subdivided, or a time point when the reconstructed mesh is generated.

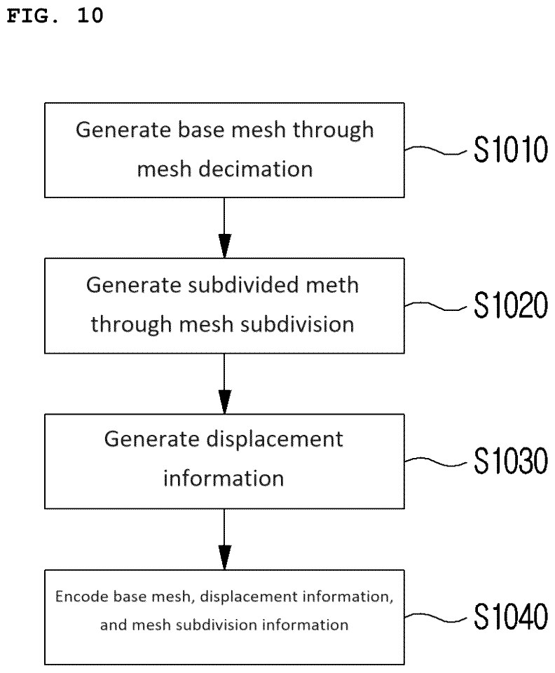

FIG. 10 is a flowchart of a method of encoding the dynamic mesh according to an embodiment of the present disclosure.

Referring to FIG. 10, first, mesh decimation may be performed on an input original mesh to generate a base mesh (S1010).

When the base mesh is input, a subdivided mesh may be generated through mesh subdivision (S1020). In this instance, as described above, mesh subdivision may be repeatedly performed a plurality of times. In addition, for each iteration, a mesh subdivision type may be independently determined.

Thereafter, displacement information may be generated for the subdivided mesh (S1030), and the displacement information and the base mesh may be encoded and signaled (S1040). Meanwhile, information about mesh subdivision in the encoder may be encoded into metadata and signaled.

Meanwhile, the in-loop filter may be applied to at least one of the base mesh, the subdivided mesh, or a restored mesh.

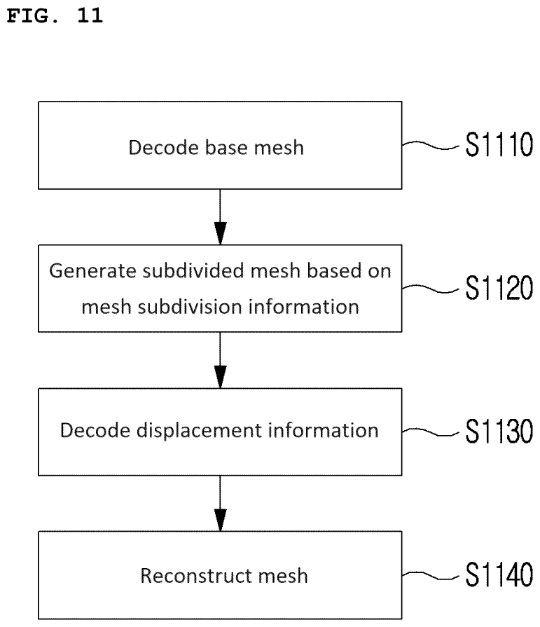

FIG. 11 is a flowchart of a method of decoding the dynamic mesh according to an embodiment of the present disclosure.

Referring to FIG. 11, first, data on the base mesh may be parsed from a bitstream, and the base mesh may be decoded (S1110).

Next, mesh subdivision may be applied to the base mesh based on mesh subdivision information signaled from the encoder (S1120). The mesh subdivision information may include at least one of whether mesh subdivision has been applied, the number of mesh subdivisions, or the mesh subdivision type.

The displacement information may be decoded (S1130), and the decoded displacement information and the subdivided mesh may be combined to generate a reconstructed mesh (S1140).

Meanwhile, the in-loop filter may be applied to at least one of the base mesh, the subdivided mesh, or the restored mesh.

According to the present disclosure, by providing a method of subdividing a base mesh generated through mesh decimation, restoration quality may be improved while reducing the amount of data to be encoded/decoded.

According to the present disclosure, there is an effect of improving objective/subjective image quality by subdividing a base mesh based on a plurality of mesh subdivision type candidates.

The present disclosure has an effect of improving objective/subjective image quality by variably setting a mesh subdivision type for each subdivision iteration.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of encoding a dynamic mesh, the method comprising:
creating a base mesh through mesh decimation;
subdividing the base mesh;
extracting displacement information for the subdivided mesh; and
encoding the base mesh and the displacement information,
wherein mesh subdivision information for subdivision of the base mesh is encoded and signaled.

2. The method according to claim 1, wherein the mesh subdivision information comprises first information indicating whether mesh subdivision is applied to the base mesh.

3. The method according to claim 2, wherein, when the mesh subdivision is applied to the base mesh, the mesh subdivision information further comprises second information indicating a number of subdivisions of the base mesh.

4. The method according to claim 3, wherein:
when the base mesh is subdivided a plurality of times, information indicating a mesh subdivision type is encoded and signaled for each iteration, and
the mesh subdivision type indicates one of a plurality of mesh subdivision type candidates.

5. The method according to claim 3, wherein:
when the base mesh is subdivided a plurality of times, a default mesh subdivision type is applied in a first iteration, and
one of the plurality of mesh subdivision type candidates is optionally used in second and subsequent iterations.

6. The method according to claim 5, wherein:
encoding of mesh subdivision type information is omitted for the first iteration, and
mesh subdivision type information indicating one of the plurality of mesh subdivision type candidates is encoded in the second and subsequent iterations.

7. The method according to claim 1, wherein, when the base mesh is subdivided, one of a plurality of subdivision type candidates is adaptively determined based on a number of vertices included in the base mesh.

8. The method according to claim 1, further comprising applying an in-loop filter to the subdivided mesh or a reconstructed mesh based on the subdivided mesh.

9. The method according to claim 8, wherein a type of the in-loop filter is adaptively determined according to a mesh subdivision type of the base mesh.

10. A method of decoding a dynamic mesh, the method comprising:
decoding a base mesh;
subdividing the base mesh;
decoding displacement information; and
restoring a mesh by applying the displacement information to a subdivided mesh,
wherein subdivision of the base mesh is performed based on mesh subdivision information decoded from a bitstream.

11. The method according to claim 10, wherein the mesh subdivision information comprises first information indicating whether mesh subdivision is applied to the base mesh.

12. The method according to claim 11, wherein, when the first information indicates that the mesh subdivision is applied to the base mesh, the mesh subdivision information further comprises second information indicating a number of subdivisions of the base mesh.

13. The method according to claim 12, wherein:
when the base mesh is subdivided a plurality of times, information indicating a mesh subdivision type is decoded for each iteration, and
the mesh subdivision type indicates one of a plurality of mesh subdivision type candidates.

14. The method according to claim 12, wherein:
when the base mesh is subdivided a plurality of times, a default mesh subdivision type is applied in a first iteration, and
one of the plurality of mesh subdivision type candidates is optionally used in second and subsequent iterations.

15. The method according to claim 14, wherein:
decoding of mesh subdivision type information is omitted for the first iteration, and
mesh subdivision type information indicating one of the plurality of mesh subdivision type candidates is decoded in the second and subsequent iterations.

16. The method according to claim 10, wherein, when the base mesh is subdivided, one of a plurality of subdivision type candidates is adaptively determined based on a number of vertices included in the base mesh.

17. The method according to claim 10, further comprising applying an in-loop filter to the subdivided mesh or the reconstructed mesh.

18. The method according to claim 17, wherein a type of the in-loop filter is adaptively determined according to a mesh subdivision type of the base mesh.

19. A computer-readable recording medium storing a method of encoding a dynamic mesh, the method comprising:
creating a base mesh through mesh decimation;
subdividing the base mesh;
extracting displacement information for the subdivided mesh; and
encoding the base mesh and the displacement information,
wherein mesh subdivision information for subdivision of the base mesh is encoded and signaled.
